(19) United States
(12) Patent Application Publication
(10) Pub. No.: US 2025/0072691 A1
(43) Pub. Date: Mar. 6, 2025

(54) METHOD FOR DOCKING CLEANING ROBOT, CLEANING ROBOT AND COMPUTER-READABLE STORAGE MEDIUM

(71) Applicants: Best Epoch Technology Co., LTD, Shenzhen (CN); UBTECH ROBOTICS CORP LTD, Shenzhen (CN)

(72) Inventors: MENG LI, Shenzhen (CN); Xiangbin Huang, Shenzhen (CN); Liuchen Yang, Shenzhen (CN); Gaobo Huang, Shenzhen (CN)

(21) Appl. No.: 18/911,202

(22) Filed: Oct. 9, 2024

Related U.S. Application Data
(63) Continuation of application No. PCT/CN2023/141820, filed on Dec. 26, 2023.

(30) Foreign Application Priority Data
Aug. 30, 2023 (CN) 202311126670.3

(51) Int. Cl. A47L 11/40; G01C 21/00

(52) U.S. Cl. CPC A47L 11/4011; A47L 11/4008; G01C 21/383; A47L 2201/022

(57) ABSTRACT

A method for docking a cleaning robot includes: obtaining a map of a scene where the cleaning robot is located, and a position of the cleaning robot in the map; determining a map contour where the position of the cleaning robot is located according to the map; determining a plurality of traversal points for searching for a charging station and a plurality of traversal areas corresponding to the plurality of traversal points according to the map contour; and searching for the charging station in the traversal areas corresponding to the traversal points according to a predetermined search order, until the charging station is found in the traversal areas, or the traversal areas corresponding to all of the traversal points have been searched.

### CROSS REFERENCE TO RELATED APPLICATIONS

The present application is a continuation-application of International Application PCT/CN2023/141820, with an international filing date of Dec. 26, 2023, which claims foreign priority of Chinese Patent Application No. 202311126670.3, filed on Aug. 30, 2023 in the China National Intellectual Property Administration of China, the contents of all of which are hereby incorporated by reference.

### TECHNICAL FIELD

The present disclosure generally relates to cleaning robots, and in particular relates to a method for docking a cleaning robot, cleaning robot and computer-readable storage medium.

### BACKGROUND

Typically, a cleaning robot is equipped with a power storage unit that enables it to work autonomously away from the charging dock. When the cleaning robot receives a recharge command, it needs to return to the charging dock for charging. Therefore, the ability to quickly and accurately find the charging dock is particularly important for the cleaning robot.

During a typical dock-searching process, if the cleaning robot starts cleaning from the charging dock, it can record the position of the charging dock when it leaves. When the cleaning robot receives a recharge command, it navigates to the previously recorded position of the charging dock to recharge.

However, if the position of the charging dock changes during the cleaning process, or if the cleaning robot does not start cleaning from the charging dock, the cleaning robot needs to find the charging dock on its own to recharge. Typically, this is done using a random roaming search method, where the charging dock is searched for based on a random path. Since the random path lacks a specific pattern, it may lead to inefficient searching.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a cleaning robot according to one embodiment.

FIG. 2 is an exemplary flowchart of a method for docking a cleaning robot according to one embodiment.

FIG. 3 is a schematic diagram of a map of a scene where the cleaning robot is located according to one embodiment.

FIG. 4 is a schematic diagram of determining a map contour according to one embodiment.

FIG. 5 is a schematic diagram of determining traversal points based on the position of the cleaning robot according to one embodiment.

FIG. 6 is an exemplary flowchart of a method for detecting whether a traversal point is repeatedly detected according to one embodiment.

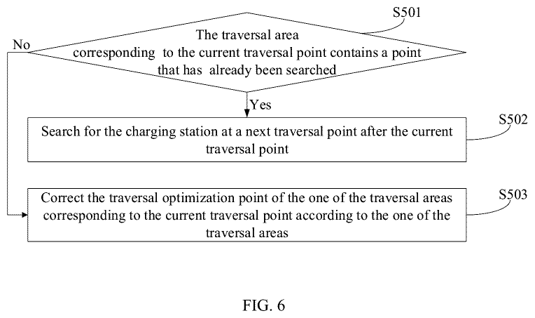

FIG. 7 is a schematic diagram of a traversal optimization point determined by the cleaning robot according to one embodiment.

FIG. 8 is an exemplary flowchart of a method for determining a traversal optimization point according to one embodiment.

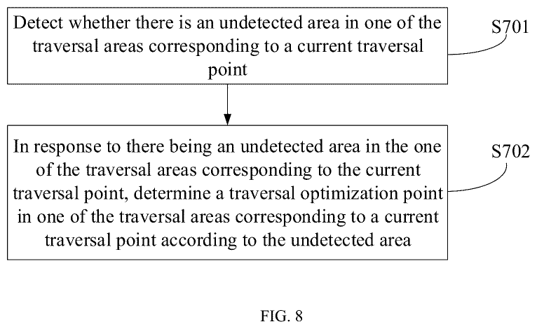

FIG. 9 is a schematic block diagram of device for docking a cleaning robot according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

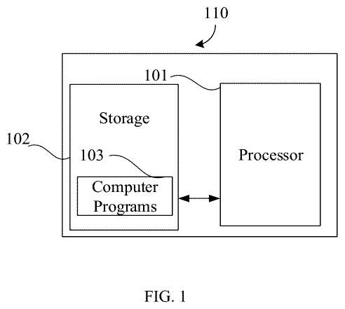

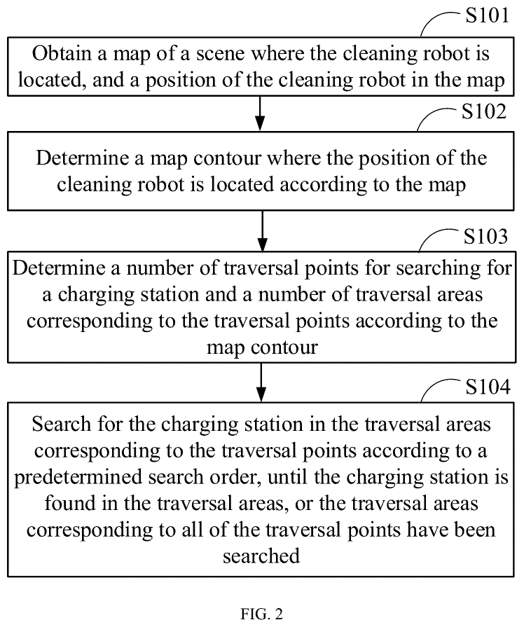

FIG. 1 shows a schematic block diagram of a cleaning robot 110 according to one embodiment. The robot 110 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of a method for docking the cleaning robot, such as steps S101 to S104 in FIG. 2 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the robot 110, such as a hard disk or a memory. The storage 102 may also be an external storage device of the robot 110, such as a plug-in hard disk, a smart memory card (SMC), and a secure digital (SD) card, or any suitable flash cards. Furthermore, the storage 102 may also include both an internal storage unit and an external storage device. The storage 102 is to store computer programs, other programs, and data required by the robot 110. The storage 102 can also be used to temporarily store data that have been output or is about to be output.

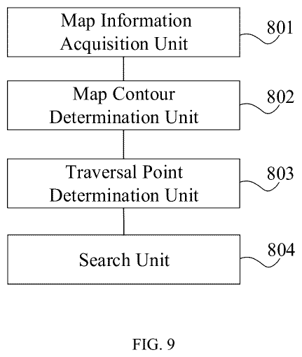

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the robot 110. For example, the one or more computer programs 103 may be divided into a map information acquisition unit 801, a map contour determination unit 802, a traversal point determination unit 803 and a search unit 804 as shown in FIG. 9.

It should be noted that the block diagram shown in FIG. 1 is only an example of the robot 110. The robot 110 may include more or fewer components than what is shown in FIG. 1, or have a different configuration than what is shown in FIG. 1. Each component shown in FIG. 1 may be implemented in hardware, software, or a combination thereof.

When a cleaning robot searches for a charging station during recharging, multiple detection points for the charging station are generally randomly set, and the cleaning robot is controlled to search for the charging station according to the detection points. Due to the randomness in the selection of detection points, it is possible that all points are checked without successfully locating the charging station, leading to low efficiency in finding the charging station.

FIG. 2 is an exemplary flowchart of a method for docking a cleaning robot according to one embodiment. As an example, but not a limitation, the method can be implemented by the robot 110. The method may include the following steps.

Step S101: Obtain a map of a scene where the cleaning robot is located, and a position of the cleaning robot in the map.

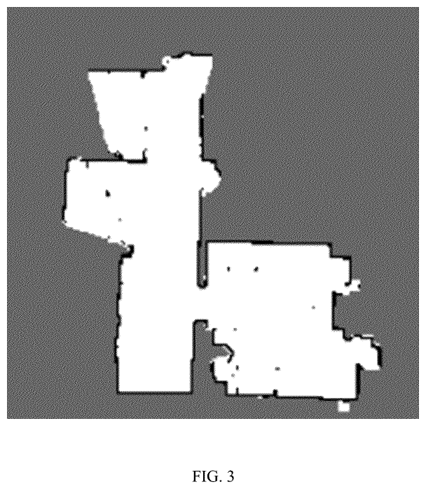

The map in the embodiment of the present disclosure may include a map of the working scene of the cleaning robot. The map may include known areas and unknown areas. The known areas may include obstacle areas and blank areas. For example, FIG. 3 shows a schematic diagram of a map of the working scene of the cleaning robot according to one embodiment. As shown in FIG. 3, the gray area represents the unknown area in the map, including the area that the robot has not explored. The unexplored area includes the areas where the unexplored obstacles are located and/or the unexplored areas where the robot can move freely. The areas where the obstacles are located include the areas behind the wall or the areas where other obstacles are located in the scene. The black areas represent the explored obstacle areas, including wall obstacles and obstacles in the room, and the white area represents the explored blank area, that is, the area where the cleaning robot can move freely.

The map of the scene where the cleaning robot is located can be generated according to a predetermined mapping method during the operation of the cleaning robot. Alternatively, a predetermined file can be read to obtain the map of the scene where the robot is located. The position of the cleaning robot in the map can be determined during the map generation process. Alternatively, after the map is generated, the position of the cleaning robot in the map can be determined by the positioning module of the cleaning robot.

Step S102: Determine a map contour where the position of the cleaning robot is located according to the map.

When determining the map contour of the map where the cleaning robot is located, the map contour included in the map can be determined according to the boundary pixels of the unknown area and the obstacle area in the map. For example, the boundary pixels of the obstacles and the boundary pixels of the unknown area can be used to obtain the contour included in the map. The map contour is the contour of the map of the scene where the cleaning robot is located.

In order to further improve the efficiency of map contour generation, the map can be binarized to obtain a binarized image. For example, the gray area (unknown area) and black areas (obstacle areas) in the map can be binarized to 0, and the white area (blank area) in the map can be binarized to 1.

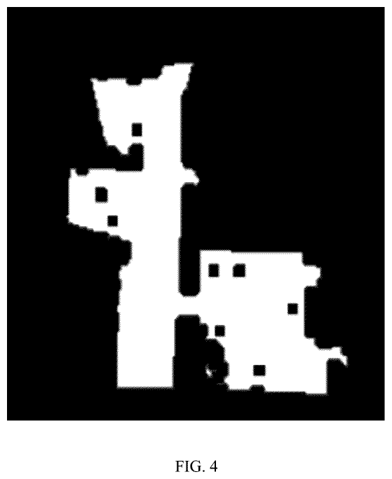

Dilation is then performed on the edge of the binarized image. For example, based on predetermined dilation parameters, dilate by n grids/pixels to obtain the dilated contour as shown in FIG. 4. As shown in FIG. 4, the black areas are the obstacle areas and unknown area after the binary processing, and the white area is the partial blank area after the binary processing. The areas between the black areas and the white area are the dilation areas, and the boundary between the dilation areas and the blank area is the contour generated after the dilation processing. After the dilation processing, the influence of noise in the image on the contour can be effectively suppressed.

Step S103: Determine a number of traversal points for searching for a charging station and a number of traversal areas corresponding to the traversal points according to the map contour.

According to the determined map contour, contour points located on the map contour may be determined as traversal points for searching for a charging station.

When determining the traversal point for the cleaning robot on the map contour, the current traversal point of the cleaning robot on the contour and the subsequent traversal point on the map contour can be determined according to the position of the previous traversal point of the cleaning robot. For example, the previous contour point selected by the robot is last_choose_connotur_point. According to a preset traversal point interval, such as an interval of m grids/pixels, the current contour point can be determined to be m_index_point. Similarly, according to this interval, the points at the positions of m_index_point+m, m_index point+2m, m_index point+3m . . . on the map contour can be determined as traversal points in the map contour for searching for a charging station.

The traversal areas corresponding to the traversal points can be defined flexibly. For example, the traversal area corresponding to each traversal point can be an area with the traversal point as the center and a radius of m/2 grid. Alternatively, the traversal area corresponding to the i-th traversal point can be the area between the i-th traversal point and the (i+1)-th traversal point.

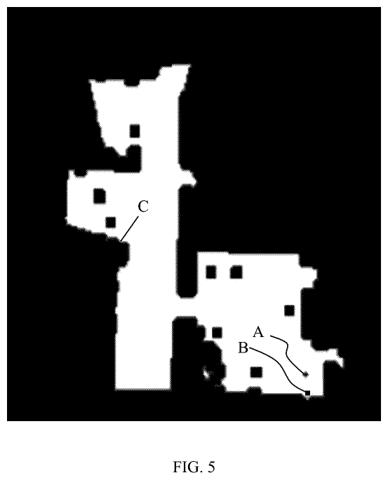

In one embodiment, if the previously selected traversal point on the contour does not exist, the current contour point can be determined based on the current position of the cleaning robot. For example, as shown in FIG. 5, when the cleaning robot is within the map contour C, point B can be determined as the current traversal point m_index point based on the position A of the cleaning robot and the nearest point B on the map contour. Then, according to a predetermined grid interval, such as an interval of m grids/pixels, other traversal points m_index_point+m, m_index_point+2m, m_index_point+3m . . . on the map contour can be determined.

Step S104: Search for the charging station in the traversal areas corresponding to the traversal points according to a predetermined search order, until the charging station is found in the traversal areas, or the traversal areas corresponding to all of the traversal points have been searched.

After determining the traversal points on the map contour, the cleaning robot can be controlled to move to each traversal point in turn in a clockwise or counterclockwise direction according to the determined traversal points to detect whether the charging station is present in the traversal area corresponding to the traversal point. If the charging station is present in the traversal area corresponding to the traversal point, the cleaning robot can be controlled to be charged on the charging station according to the position of the detected charging station. If the charging station of the cleaning robot is not detected at the current traversal point, the cleaning robot can be moved to the next traversal point to detect whether the charging station is present in the traversal area corresponding to the traversal point. The traversal detection process ends until the charging pile is detected in one of the traversal areas. Alternatively, if all traversal points have been checked without detecting the charging dock, the traversal detection process ends.

In one embodiment, in order to further improve the traversal efficiency, when searching for the charging station in the traversal areas corresponding to the traversal points, a process of detecting whether one traversal point has been repeatedly detected may be further included, as shown in FIG. 5, including the following steps.

Step S501: Detect whether one of the traversal areas corresponding to a current traversal point contains a point that has already been searched.

The point that has been searched can be the point where the search for the charging station has been performed within a predetermined time period from the current time, and the charging station is not detected at this point. Alternatively, the point that has been searched can be the point where the search for the charging station has been performed during this recharging, and the charging station is not detected at this point. Alternatively, the point that has been searched can be a point where the charging station was previously searched for but not detected at the previous charging cycle.

If the point that has been searched is present in the traversal area corresponding to a traversal point, it means that the search for the charging station has been performed for the point in the traversal area. Due to the short time interval between the previous detection and the current time, such as when the interval is shorter than a predetermined time threshold, it indicates that the likelihood of detecting the charging station at this traversal point is low.

Step S502: In response to the one of the traversal areas corresponding to the current traversal point containing the point that has already been searched, search for the charging station at a next traversal point after the current traversal point.

If there is a point where search for the charging station has been performed within the predetermined duration before the current time, due to the short interval between the two searches, it can be determined based on the previous search results that there is no charging station at the current traversal point. Then, next traversal point after the current traversal point is determined and search for the charging station can be performed based on the traversal area corresponding to the next traversal point.

Step S503: In response to no point that has already been searched being present in the one of the traversal areas corresponding to the current traversal point, correct the traversal optimization point of the one of the traversal areas corresponding to the current traversal point according to the one of the traversal areas.

If the point where search for the charging station has been performed is not present in the traversal area corresponding to the current traversal point, it means that there is no valid detection record before, and the charging station detection can be performed according to the current traversal point. For example, the cleaning robot can be moved to the traversal point to detect the charging station.

In one embodiment, in order to optimize the detection efficiency, the method further optimizes the traversal points before traversal, so that the selected points can be away from obstacles or in an open area. Thus, traversal optimization points are obtained, and the charging station detection can be performed according to the traversal optimization points.

In one embodiment, the traversal optimization point of the one of the traversal areas corresponding to the current traversal point is corrected according to one of one or more of the following conditions: The traversal optimization point is located within the map contour. No points have been searched within a predetermined range centered on the traversal optimization point. A distance between the traversal optimization point and each of one or more obstacles is greater than a predetermined threshold.

The area enclosed by the map outline is a blank area, which is the area that the cleaning robot can reach. The areas outside the contour may include obstacle areas and/or an unknown area. In order to make the traversal optimization point reliable and effective, it needs to first determine that the traversal optimization point is within the map contour. Through this condition, points outside the map contour can be filtered out.

In order to make the traversal optimization point effective, the search range determined by the traversal optimization point needs to be an effective search range. For example, the predetermined range can be a range covered by a circle formed with a predetermined radius centered on the traversal optimization point. There is no point where the search for a charging station has been performed within the determined predetermined range. That is, within the predetermined range, no charging station detection has been performed within the predetermined time before the current time. Then, the effectiveness of the acquired charging station detection information can be improved through the traversal optimization point.

Since the charging station itself has a certain width (i.e., the distance from the front to the back), when detecting the charging station close to an obstacle, the obstacle can be effectively detected from the front of the charging station that faces the obstacle. Therefore, the distance between the traversal optimization point and the obstacle can be set to be greater than a predetermined distance threshold. For example, the distance threshold can be greater than or equal to the width of the cleaning robot.

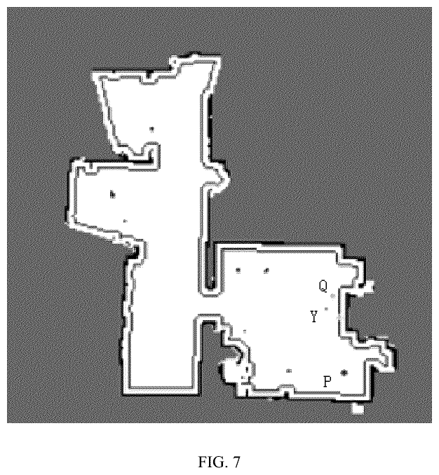

FIG. 7 is a schematic diagram of the traversal optimization point determined by the cleaning robot. As shown in FIG. 7, the current position of the cleaning robot is point P, and according to the grid interval on the contour, the next traversal point is determined to be point Q. By optimizing and correcting the position of the traversal point, the optimized traversal point can be obtained. That is, the traversal optimization point is point Y.

When searching for the charging station in the traversal areas corresponding to the traversal points, there may be undetected areas in the traversal areas. In order to avoid the possibility of the charging station in the undetected areas, as shown in FIG. 7, the method may further include the following steps.

Step S701: Detect whether there is an undetected area in one of the traversal areas corresponding to a current traversal point.

When determining whether there is an undetected area in one traversal area, it can be determined whether there is a contour of an unknown area in the map outline in the traversal area, and whether the contour of the unknown area is greater than a predetermined length. For example, if the length of the contour of the unknown area is greater than M grids, it means that there is an undetected area in the traversal area.

For the detection of the undetected area, after determining that there is a point where the search for the charging station has been performed in the traversal area, detection of the undetected area in the traversal area can be performed.

Step S702: In response to there being an undetected area in the one of the traversal areas corresponding to the current traversal point, determine a traversal optimization point in one of the traversal areas corresponding to a current traversal point according to the undetected area.

Since the charging station may be present in the undetected area, in order to more reliably detect the charging station in the undetected area, the Nth (N is less than or equal to M) undetected point among the continuous unknown points on the map contour can be set as the traversal optimization point, and the traversal optimization point is used as the detection point of the charging station. When the cleaning robot moves to the traversal optimization point, obstacle detection can be performed on the undetected area, so that the detection information in the undetected area is more complete, and the undetected area becomes a detected area. The charging station detection is thus performed at the traversal optimization point, which can effectively detect the charging station in the unknown range.

In one embodiment, after determining that the Nth consecutive unknown point on the map contour is a traversal optimization point, it can be further optimized according to the above-mentioned optimization conditions of the traversal optimization point.

If there is no undetected area in the traversal area corresponding to the current traversal point, it is further determined according to step S703 whether there is a point where the search for the charging station has been performed in the traversal area. If the point where the search for the charging station has been performed is present in the traversal area, the next traversal point can be determined. If the point where the search for the charging station has been performed is not present in the traversal area, the traversal point can be optimized.

In summary, according to the embodiments described above, the map of a scene where the cleaning robot is located and a position of the cleaning robot in the map are first obtained. The map contour where the position of the cleaning robot is located is then determined according to the map. Multiple traversal points for searching for a charging station are then determined. Search for the charging station is then performed in the traversal areas corresponding to the traversal points according to a predetermined search order, until the charging station is found in the traversal areas, or the traversal areas corresponding to all of the traversal points have been searched. Through the traversal points determined by the contour, the charging station search is quickly performed in a predetermined order, which is beneficial to improving the efficiency of the charging station search.

In addition, by detecting whether there are points where search for the charging station has been performed in the traversal areas, repeated charging station search can be reduced, which can effectively improve the efficiency of finding the charging station.

By detecting unknown areas in the traversal areas, charging station detection can be performed in the unknown area, and the map can be effectively improved to improve the completeness of the map information.

By optimizing the positions of the traversal points, the traversal optimization points are obtained, which is helpful to improve the efficiency of traversing and searching for the charging station.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

FIG. 9 is a schematic block diagram of a device for docking a cleaning robot. In one embodiment, the device may include a map information acquisition unit 801, a map contour determination unit 802, a traversal point determination unit 803 and a search unit 804. The map information acquisition unit 801 is to obtain a map of a scene where the cleaning robot is located, and a position of the cleaning robot in the map. The map contour determination unit 802 is to determine a map contour where the position of the cleaning robot is located according to the map. The traversal point determination unit 803 is to determine a number of traversal points for searching for a charging station and a number of traversal areas corresponding to the traversal points according to the map contour. The search unit 804 is to search for the charging station in the traversal areas corresponding to the traversal points according to a predetermined search order, until the charging station is found in the traversal areas, or the traversal areas corresponding to all of the traversal points have been searched. The device shown in FIG. 9 corresponds to the method shown in FIG. 2.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for docking a cleaning robot, the method comprising:
obtaining a map of a scene where the cleaning robot is located, and a position of the cleaning robot in the map;
determining a map contour where the position of the cleaning robot is located according to the map;
determining a plurality of traversal points for searching for a charging station and a plurality of traversal areas corresponding to the plurality of traversal points according to the map contour; and
searching for the charging station in the traversal areas corresponding to the traversal points according to a predetermined search order, until the charging station is found in the traversal areas, or the traversal areas corresponding to all of the traversal points have been searched.

2. The method of claim 1, wherein searching for the charging station in the traversal areas corresponding to the traversal points comprises:
detecting whether one of the traversal areas corresponding to a current traversal point contains a point that has already been searched; and
in response to the one of the traversal areas corresponding to the current traversal point containing the point that has already been searched, searching for the charging station at a next traversal point after the current traversal point.

3. The method of claim 1, wherein searching for the charging station in the traversal areas corresponding to the traversal points comprises:
detecting whether there is an undetected area in one of the traversal areas corresponding to a current traversal point; and
in response to there being an undetected area in the one of the traversal areas corresponding to the current traversal point, determining a traversal optimization point in one of the traversal areas corresponding to a current traversal point according to the undetected area.

4. The method of claim 3, wherein detecting whether there is the undetected area in the one of the traversal areas corresponding to the current traversal point comprises:
detecting whether one of the traversal areas corresponding to the current traversal point contains more than M consecutive unknown points; and
determining the traversal optimization point in the one of the traversal areas corresponding to the current traversal point according to the undetected area comprises:
in the one of the traversal areas corresponding to the current traversal point, determining an Nth of the unknown points as the traversal optimization point of the one of the traversal areas corresponding to the current traversal point, wherein M and N are natural numbers, and M is greater than or equal to N.

5. The method of claim 2, further comprising, after detecting whether one of the traversal areas corresponding to a current traversal point contains a point that has already been searched,
in response to the one of the traversal areas corresponding to the current traversal point not containing the point that has already been searched, correcting the traversal optimization point of the one of the traversal areas corresponding to the current traversal point according to the one of the traversal areas.

6. The method of claim 5, wherein the traversal optimization point of the one of the traversal areas corresponding to the current traversal point is corrected according to one of one or more of the following conditions:
the traversal optimization point is located within the map contour;
no points have been searched within a predetermined range centered on the traversal optimization point; and
a distance between the traversal optimization point and each of one or more obstacles is greater than a predetermined threshold.

7. The method of claim 1, wherein determining the map contour where the position of the cleaning robot is located according to the map comprises:
binarizing the map to obtain a binarized image; and
performing dilation on the binarized image to obtain the map contour corresponding to the map.

8. A cleaning robot comprising:
one or more processors; and
a memory coupled to the one or more processors, the memory storing programs that, when executed by the one or more processors, cause performance of operations comprising:
obtaining a map of a scene where the cleaning robot is located, and a position of the cleaning robot in the map;
determining a map contour where the position of the cleaning robot is located according to the map;
determining a plurality of traversal points for searching for a charging station and a plurality of traversal areas corresponding to the plurality of traversal points according to the map contour; and
searching for the charging station in the traversal areas corresponding to the traversal points according to a predetermined search order, until the charging station is found in the traversal areas, or the traversal areas corresponding to all of the traversal points have been searched.

9. The cleaning robot of claim 8, wherein searching for the charging station in the traversal areas corresponding to the traversal points comprises:
detecting whether one of the traversal areas corresponding to a current traversal point contains a point that has already been searched; and
in response to the one of the traversal areas corresponding to the current traversal point containing the point that has already been searched, searching for the charging station at a next traversal point after the current traversal point.

10. The cleaning robot of claim 8, wherein searching for the charging station in the traversal areas corresponding to the traversal points comprises:
detecting whether there is an undetected area in one of the traversal areas corresponding to a current traversal point; and
in response to there being an undetected area in the one of the traversal areas corresponding to the current traversal point, determining a traversal optimization point in one of the traversal areas corresponding to a current traversal point according to the undetected area.

11. The cleaning robot of claim 10, wherein detecting whether there is the undetected area in the one of the traversal areas corresponding to the current traversal point comprises:
detecting whether one of the traversal areas corresponding to the current traversal point contains more than M consecutive unknown points; and
determining the traversal optimization point in the one of the traversal areas corresponding to the current traversal point according to the undetected area comprises:
in the one of the traversal areas corresponding to the current traversal point, determining an Nth of the unknown points as the traversal optimization point of the one of the traversal areas corresponding to the current traversal point, wherein M and N are natural numbers, and M is greater than or equal to N.

12. The cleaning robot of claim 9, wherein the operations further comprise, after detecting whether one of the traversal areas corresponding to a current traversal point contains a point that has already been searched,
in response to the one of the traversal areas corresponding to the current traversal point not containing the point that has already been searched, correcting the traversal optimization point of the one of the traversal areas corresponding to the current traversal point according to the one of the traversal areas.

13. The cleaning robot of claim 12, wherein the traversal optimization point of the one of the traversal areas corresponding to the current traversal point is corrected according to one of one or more of the following conditions:
the traversal optimization point is located within the map contour;
no points have been searched within a predetermined range centered on the traversal optimization point; and
a distance between the traversal optimization point and each of one or more obstacles is greater than a predetermined threshold.

14. The cleaning robot of claim 8, wherein determining the map contour where the position of the cleaning robot is located according to the map comprises:
binarizing the map to obtain a binarized image; and
performing dilation on the binarized image to obtain the map contour corresponding to the map.

15. A non-transitory computer-readable storage medium storing instructions that, when executed by at least one processor of a cleaning robot, cause the at least one processor to perform a method, the method comprising:
obtaining a map of a scene where the cleaning robot is located, and a position of the cleaning robot in the map;
determining a map contour where the position of the cleaning robot is located according to the map;
determining a plurality of traversal points for searching for a charging station and a plurality of traversal areas corresponding to the plurality of traversal points according to the map contour; and
searching for the charging station in the traversal areas corresponding to the traversal points according to a predetermined search order, until the charging station is found in the traversal areas, or the traversal areas corresponding to all of the traversal points have been searched.

16. The non-transitory computer-readable storage medium of claim 15, wherein searching for the charging station in the traversal areas corresponding to the traversal points comprises:
detecting whether one of the traversal areas corresponding to a current traversal point contains a point that has already been searched; and
in response to the one of the traversal areas corresponding to the current traversal point containing the point that has already been searched, searching for the charging station at a next traversal point after the current traversal point.

17. The non-transitory computer-readable storage medium of claim 15, wherein searching for the charging station in the traversal areas corresponding to the traversal points comprises:
detecting whether there is an undetected area in one of the traversal areas corresponding to a current traversal point; and
in response to there being an undetected area in the one of the traversal areas corresponding to the current traversal point, determining a traversal optimization point in one of the traversal areas corresponding to a current traversal point according to the undetected area.

18. The non-transitory computer-readable storage medium of claim 17, wherein detecting whether there is the undetected area in the one of the traversal areas corresponding to the current traversal point comprises:
detecting whether one of the traversal areas corresponding to the current traversal point contains more than M consecutive unknown points; and
determining the traversal optimization point in the one of the traversal areas corresponding to the current traversal point according to the undetected area comprises:
in the one of the traversal areas corresponding to the current traversal point, determining an Nth of the unknown points as the traversal optimization point of the one of the traversal areas corresponding to the current traversal point, wherein M and N are natural numbers, and M is greater than or equal to N.

19. The non-transitory computer-readable storage medium of claim 16, further comprising, after detecting whether one of the traversal areas corresponding to a current traversal point contains a point that has already been searched,
in response to the one of the traversal areas corresponding to the current traversal point not containing the point that has already been searched, correcting the traversal optimization point of the one of the traversal areas corresponding to the current traversal point according to the one of the traversal areas.

20. The non-transitory computer-readable storage medium of claim 19, wherein the traversal optimization point of the one of the traversal areas corresponding to the current traversal point is corrected according to one of one or more of the following conditions:
the traversal optimization point is located within the map contour;
no points have been searched within a predetermined range centered on the traversal optimization point; and
a distance between the traversal optimization point and each of one or more obstacles is greater than a predetermined threshold.
